(19) United States
(12) Patent Application Publication
(10) Pub. No.: US 2009/0280678 A1
(43) Pub. Date: Nov. 12, 2009

(54) LIGHT GUIDING STRUCTURE FOR ELECTRIC CONNECTOR

(75) Inventor: Haven Yang, Chung Ho City (TW)

Correspondence Address: APEX JURIS, PLLC, 12733 LAKE CITY WAY NORTHEAST, SEATTLE, WA, 98125, US

(73) Assignee: ALL BEST ELECTRONICS CO., LTD., Chung Ho City (TW)

(21) Appl. No.: 12/117,431

(22) Filed: May 8, 2008

(51) Int. Cl. H01R 3/00

(52) U.S. Cl. 439/490

(57) ABSTRACT

A light guiding structure for electric connector includes a base being provided on a front end surface with a plurality of sockets; at least two light-guiding units, each of which including at least two corresponding light guides and two mounting sections opposite to the light guides for mounting to two lateral surfaces of the base; a coupler coupled with the light guides of the light-guiding units; and an enclosure enclosing the base, the light-guiding units, and the coupler therein. The enclosure includes a top cover connected to the base and the coupler, a bottom plate connected to a lower open side of the top cover, and a back cover connected to the base and a rear open side of the top cover; and the top cover and the back cover are provided at respective lower edges with a plurality of insertion tabs.

### FIELD OF THE INVENTION

The present invention relates to a light guiding structure for electric connector, and more particularly to a light guiding structure for electric connector that includes a base, at least two light-guiding units, a coupler, and an enclosure that can be easily and firmly assembled together.

### BACKGROUND OF THE INVENTION

In a conventional light guiding structure for electric connector as shown in FIG. 9, there is included a base 50, two light guides 51, a fixing block 52, two clamping plates 53, a cover 54, a bottom plate 55, a back plate 56, and a fixing frame 57. To assemble the light guiding structure, first extend hooked portions 511 on one end of the two light guides 51 into through holes 501 provided on a front end surface of the base 50, so that the two light guides 51 are vertically stacked. Then, couple the fixing block 52 to another end of the two light guides 51 opposite to the hooked portions 511, and insert one end of the two clamping plates 53 into slots 502 provided on the front end surface of the base 50, so that the two clamping plates 53 are separately located above and below the assembled fixing block 52 and light guides 51. Thereafter, enclose a subassembly of the base 50, the light guides 51, the fixing block 52, and the clamping plates 53 in the cover 54. Finally, connect the bottom plate 55, the back plate 56, and the fixing frame 57 to the cover 54 to complete the light guiding structure for an electric connector.

Since the light guides 51 are associated with the base 50 simply through engagement of the hooked portions 511 of the light guides 51 with the through holes 501 on the front end surface of the base 50, the light guides 51 could not be firmly and stably connected to the base 50 and tend to sway relative to the base 50. And, to enclose the subassembly of the base 50, the light guides 51, the fixing block 52, and the clamping plates 53 in the cover 54, an operator has to hold the subassembly with one hand while using the other hand to slightly expand the cover 54. The subassembly has a relatively large overall length, and the light guides 51 are easily subject to sway and accordingly deflection under even a minor external force. That is, the subassembly of the base 50, the light guides 51, the fixing block 52, and the clamping plates 53 has an unstable structure, and it would be difficult for the operator to securely hold the subassembly with only one hand. As a result, it is uneasy to enclose the subassembly in the cover 54 to complete the assembling of the light guiding structure for the electric connector.

### SUMMARY OF THE INVENTION

A primary object of the present invention is to provide a light guiding structure for electric connector, in which a base, at least two light-guiding units, a coupler, and an enclosure can be easily and firmly assembled together.

To achieve the above and other objects, the light guiding structure for electric connector according to the present invention includes a base being provided on a front end surface with a plurality of sockets; at least two light-guiding units, each of which including at least two corresponding light guides and two mounting sections opposite to the light guides for mounting to two lateral surfaces of the base; a coupler coupled with the light guides of the light-guiding units; and an enclosure enclosing the base, the light-guiding units, and the coupler therein. The enclosure includes a top cover connected to the base and the coupler, a bottom plate connected to a lower open side of the top cover, and a back cover connected to the base and a rear open side of the top cover. And, the top cover and the back cover are provided at respective lower edges with a plurality of insertion tabs.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a light guiding structure for electric connector according to a first embodiment of the present invention;

FIG. 2 is an assembled view of FIG. 1;

FIG. 3 is a rear view of FIG. 2;

FIG. 4 is a sectional view taken along line A-A of FIG. 3;

FIG. 5 is a side view of FIG. 2;

FIG. 6 is a sectional view taken along line B-B of FIG. 5;

FIG. 7 is an exploded perspective view of a light guiding structure for electric connector according to a second embodiment of the present invention;

FIG. 8 is an assembled view of FIG. 7; and

FIG. 9 is an exploded perspective view of a conventional light guiding structure for electric connector.

### DETAILED DESCRIPTION OF THE PREFERRED EMBODIMENTS

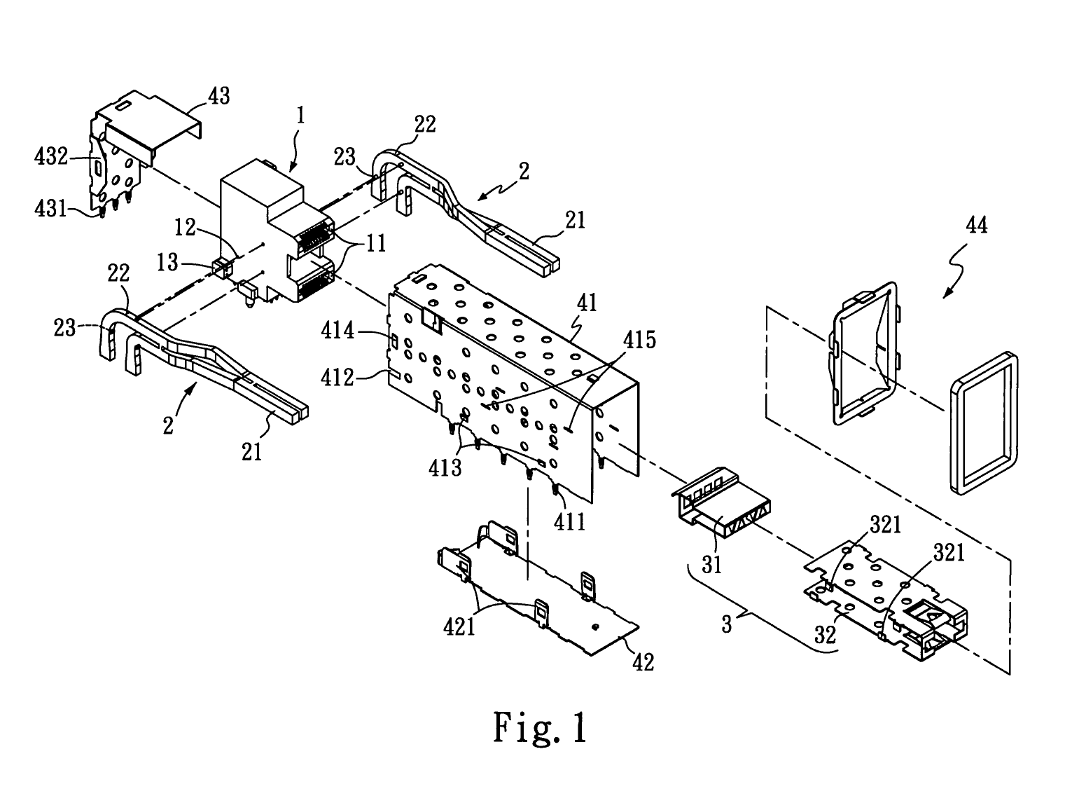

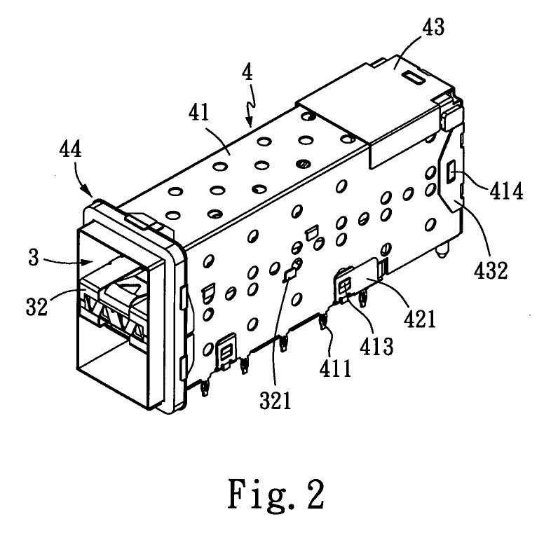

Please refer to FIGS. 1 and 2 that are exploded and assembled perspective views, respectively, of a light guiding structure for an electric connector according to a first embodiment of the present invention. As shown, the present invention includes a base 1, at least two light-guiding units 2, a coupler 3, and an enclosure 4.

The base 1 is provided on a front end surface with a plurality of sockets 11, and at predetermined positions on two lateral surfaces with a plurality of locating holes 12 and a plurality of locating blocks 13.

The light-guiding units 2 are mounted to the two lateral surfaces of the base 1. The light-guiding units 2 each include at least two corresponding light guides 21, and two mounting sections 22 opposite to the light guides 21 for mounting to the lateral surfaces of the base 1. The mounting sections 22 are provided with a plurality of locating protrusions 23 corresponding to the locating holes 12 on the lateral surfaces of the base 1.

The coupler 3 is coupled with the light guides 21 of the light-guiding units 2. The coupler 3 consists of an engaging member 31 for fitting on the light guides 21, and a locating member 32 located outside the engaging member 31. The locating member 32 is provided at lateral edges with a plurality of lugs 321. The engaging member 32 and the locating member 32 may be integrally formed as one unit, or be separately formed as two members.

The enclosure 4 is designed to enclose the base 1, the light-guiding units 2, and the coupler 3 therein. The enclosure 4 consists of a top cover 41 for connecting to the base 1 and the coupler 3, a bottom plate 42 for connecting to a lower open side of the top cover 41, and a back cover 43 for connecting to the base 1 and a rear open side of the top cover 41.

The top cover 41 and the back cover 43 are provided at respective lower edges with a plurality of insertion tabs 411, 431. The top cover 41 is provided near a rear portion with notches 412 corresponding to the locating blocks 13 on the lateral surfaces of the base 1. The top cover 41 is also provided near the insertion tabs 411 and the notches 412 with a plurality of spring leaves 413, 414, and on two lateral walls with a plurality of slits 415 each.

The bottom plate 42 and the back cover 43 are respectively provided with brackets 421 and 432 corresponding to the spring leaves 413 and 414.

The enclosure 4 also includes a fixing frame 44 fitted around a front end of the enclosure 4 to hold the top cover 41 and the bottom plate 42 together.

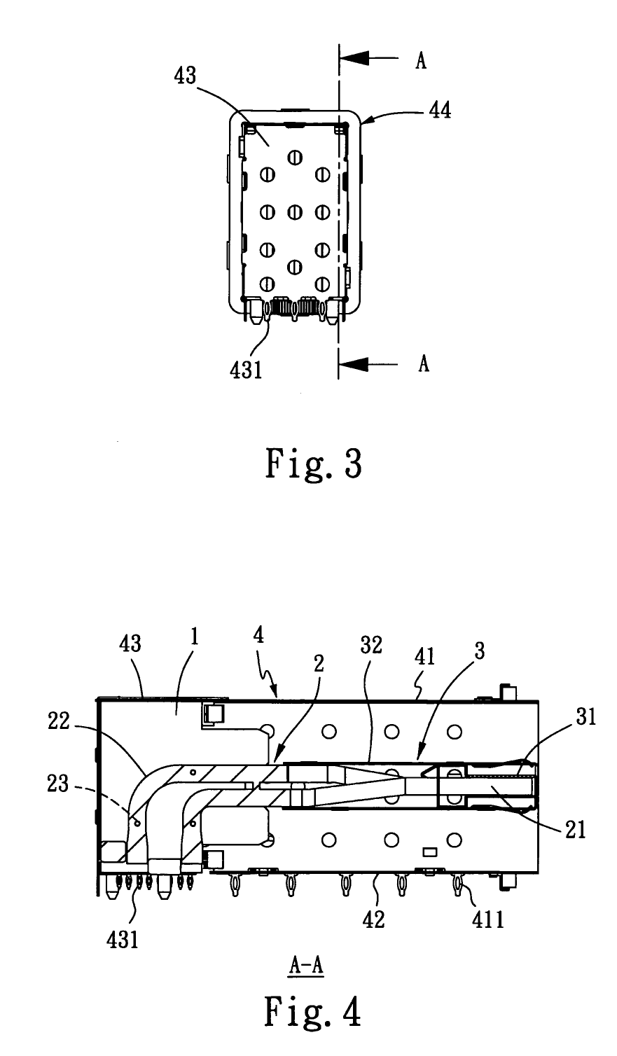

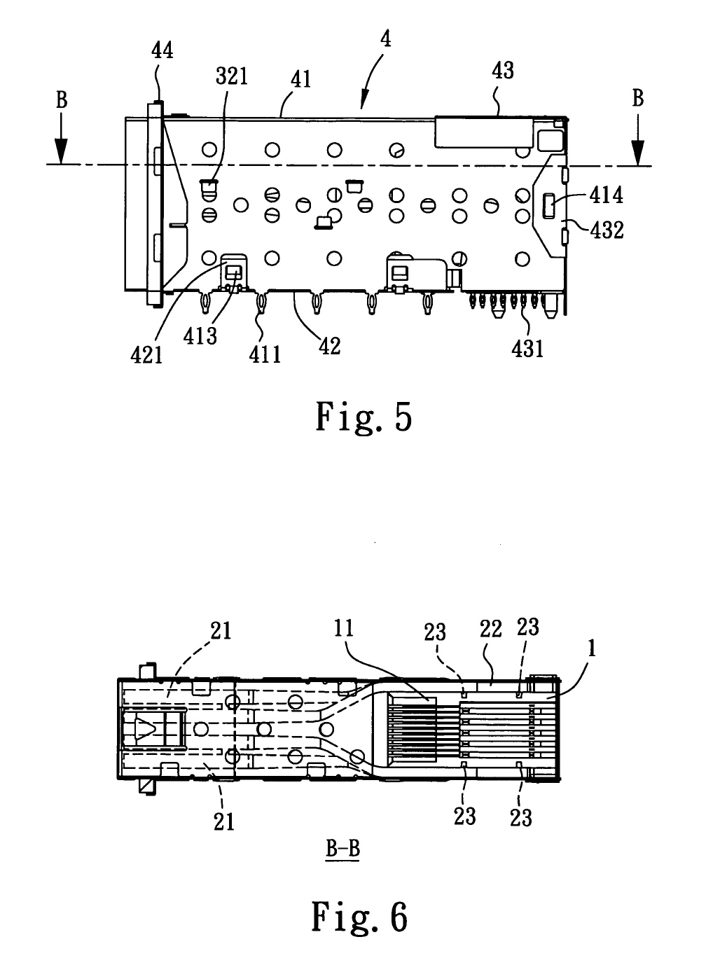

Please also refer to FIGS. 3 and 5 that are assembled end view and side view, respectively, of the present invention, and to FIGS. 4 and 6 that are sectional views taken along line A-A of FIG. 3 and line B-B of FIG. 5, respectively. To assemble the present invention, first mount the mounting sections 22 of the light-guiding units 2 to the two lateral surfaces of the base 1 with the locating protrusions 23 on the mounting sections 22 received in the locating holes 12 on the base 1, so that the mounting sections 22 of the light-guiding units 2 are in surface contact with the lateral surfaces of the base 1 to be more stably connected to the base 1. Then, extend the light guides 21 of the light-guiding units 2 through the engaging member 31 of the coupler 3 for the engaging member 31 to fit around the light guides 21. Thereafter, put the locating member 32 at an outer side of the engaging member 31, and close the top cover 41 of the enclosure 4 onto a subassembly of the base 1, the light-guiding units 2, and the coupler 3, such that the notches 412 on the top cover 41 are engaged with the locating blocks 13 on the base 1 to secure the base 1 to the top cover 41, and the lugs 321 on the lateral edges of the locating member 32 are outward extended through the slits 415 on the lateral walls of the top cover 41. The lugs 321 outward extended through the slits 415 are then bent to secure the coupler 3 to the top cover 41. Finally, engage the brackets 421, 432 on the bottom plate 42 and the back cover 43 with the spring leaves 413 and 414 on the top cover 41, respectively, and put the fixing frame 44 around the top cover 41 and the bottom plate 42 near the front end of the enclosure 4. In this manner, the base, the light-guiding units 2, the coupler 3, and the enclosure 4 can be easily and firmly assembled together.

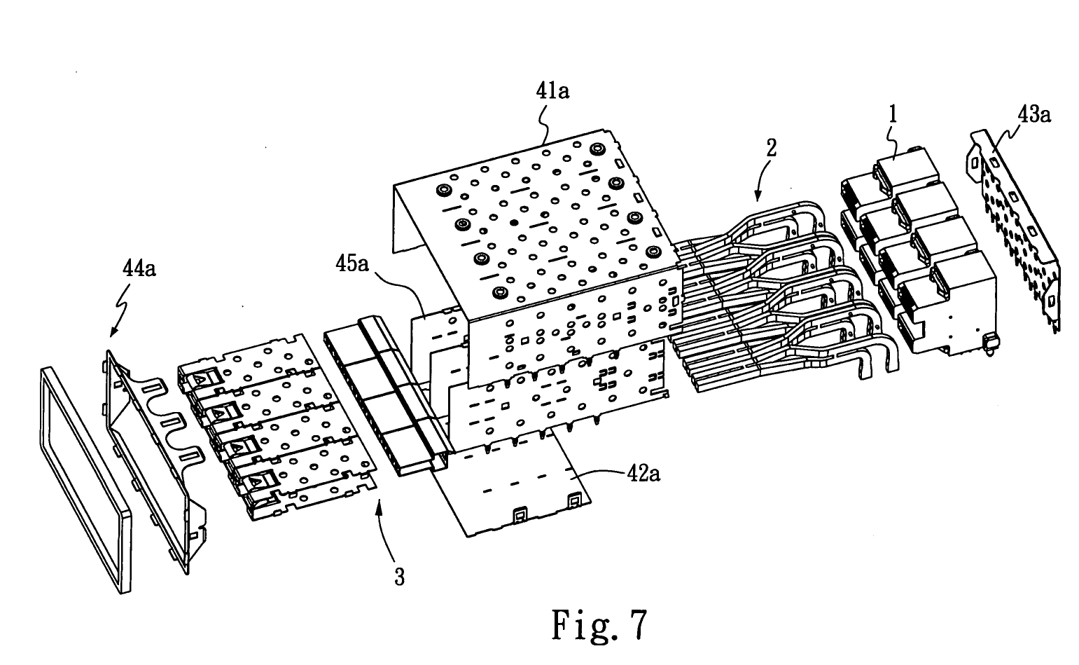

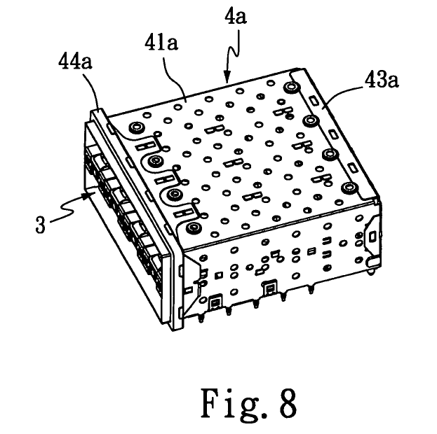

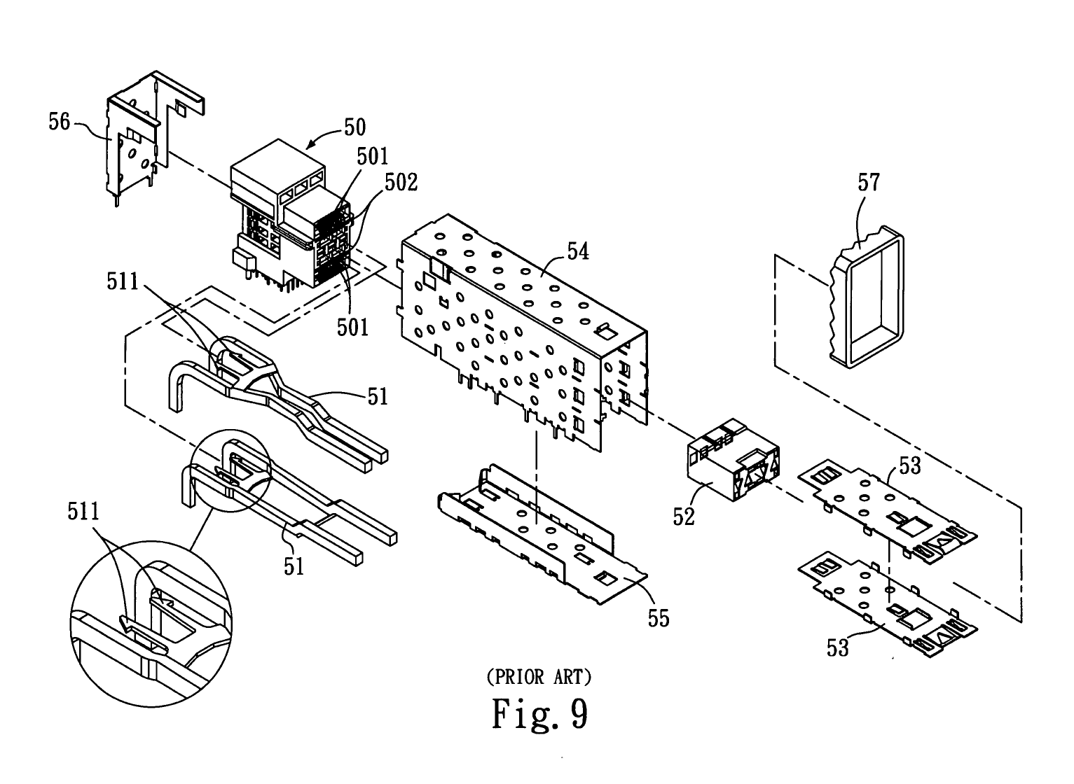

FIGS. 7 and 8 are exploded and assembled perspective views, respectively, of a second embodiment of the present invention. As shown, the second embodiment includes a plurality of parallelly arranged bases 1, and an enlarged enclosure 4a consisting of a top cover 41a, a bottom plate 42a, a back cover 43a, and a fixing frame 44a for enclosing the plurality of parallelly arranged bases 1 therein. A plurality of light-guiding units 2 in a number corresponding to that of the bases 1 is mounted to the lateral surfaces of the bases 1 and assembled to the couplers 3 in the same manner as that in the first embodiment. In the second embodiment, there are further provided a plurality of partitions 45a for separating the light-guiding units 2 from one another.

With the increased number of bases 1, light-guiding units 2, and couplers 3, the light guiding structure for electric connector according to the second embodiment of the present invention is more practical for use and may still be easily and firmly assembled.

The present invention has been described with some preferred embodiments thereof and it is understood that many changes and modifications in the described embodiments can be carried out without departing from the scope and the spirit of the invention that is intended to be limited only by the appended claims.

1. A light guiding structure for an electric connector, comprising:
a base being provided on a front end surface with a plurality of sockets;
at least two light-guiding units being separately mounted to two lateral surfaces of the base; each of the light-guiding units including at least two corresponding light guides and two mounting sections opposite to the light guides for mounting to the lateral surfaces of the base;
a coupler being coupled with the light guides of the light-guiding units; and
an enclosure for enclosing the base, the light-guiding units, and the coupler therein;
the enclosure including a top cover for connecting to the base and the coupler, a bottom plate for connecting to a lower open side of the top cover, and a back cover for connecting to the base and a rear open side of the top cover; and the top cover and the back cover being provided at respective lower edges with a plurality of insertion tabs.

2. The light guiding structure for electric connector as claimed in claim 1, wherein the base is provided at predetermined positions on the lateral surfaces with a plurality of locating holes and a plurality of locating blocks; and
the locating blocks being adapted to engage with the top cover.

3. The light guiding structure for electric connector as claimed in claim 1, wherein the mounting sections of the light-guiding units each is provided with a plurality of locating protrusions for securing to the lateral surfaces of the base.

4. The light guiding structure for electric connector as claimed in claim 1, wherein the coupler consists of an engaging member for fitting on the light guides of the light-guiding units, and a locating member located outside the engaging member; and
the locating member being provided at lateral edges with a plurality of lugs for securing to the top cover.

5. The light guiding structure for electric connector as claimed in claim 4, wherein the engaging member and the locating member are integrally formed as one unit.

6. The light guiding structure for electric connector as claimed in claim 4, wherein the engaging member and the locating member are separately formed as two members.

7. The light guiding structure for electric connector as claimed in claim 1, wherein the top cover is provided near a rear portion with notches; and
wherein the top cover is also provided near the insertion tabs and the notches with a plurality of spring leaves, and provided on two lateral walls with a plurality of slits each, and the bottom plate and the back cover are respectively provided with brackets for engaging with the spring leaves.

8. The light guiding structure for electric connector as claimed in claim 1, wherein the enclosure further includes a fixing frame for fitting around a front end of the enclosure to hold the top cover and the bottom plate together.
